(19) United States
(12) Patent Application Publication
(10) Pub. No.: US 2005/0200038 A1
(43) Pub. Date: Sep. 15, 2005

(54) Method for controlling a rotary tablet press and such a press

(75) Inventors: Jan Vogeleer, Bornem (BE); Jurgen Boeckx, Steenokkerzeel (BE); Ivo Van Den Mooter, Willebroek (BE); Wouter Happaerts, Walem (BE)

Correspondence Address: SUGHRUE MION, PLLC, 2100 PENNSYLVANIA AVENUE, N.W., SUITE 800, WASHINGTON, DC, 20037, US

(73) Assignee: COURTOY NV

(21) Appl. No.: 10/798,321

(22) Filed: Mar. 12, 2004

(51) Int. Cl. B28B 7/00

(52) U.S. Cl. 264/40.1; 425/148; 425/149; 425/353; 264/40.4; 264/109

(57) ABSTRACT

A method for controlling a rotary tablet press comprises the steps of consecutively supplying material into each die of a die table, subjecting the material to a pre-compression and a main-compression, measuring, during the pre-compression, a value representative of the weight of material compressed, and during the main-compression, a value representative of the hardness of the resulting tablet. The quantity of material supplied to each die is regulated on the basis of a deviation between a measured value representative of the weight and a first set value. The degree of compression during main-compression is regulated on the basis of a deviation between a measured value representative of the hardness and a second set value.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to a method for controlling a tablet press, whereby powder or granular material is compressed in dies arranged circumferentially in a rotary die table by means of reciprocating punches.

Furthermore, the present invention relates to a rotary tablet press comprising a housing and a rotary die table having a number of dies arranged circumferentially, each die being associated with first and second punches, each punch having first and second ends, said first punch ends being receivable in the die and arranged for compression of a powder or granular material in the die.

In prior art tablet presses, the quantity of material supplied to each die is automatically regulated during production on the basis of previously measured values of a parameter representative of the weight of the quantity of material compressed.

GB 1 534 061 (Courtoy) discloses a rotary tablet press, whereby the weight of tablets is regulated by retroactive control of their size when compressed at substantially constant pressure during manufacture. The die fill depth is regulated on the basis of measured displacement values of one of the compression rollers during compression of tablets. The displaceable compression roller is suspended in a piston slidable in a cylinder, the internal pressure of which is maintained constant.

U.S. Pat. No. 3,734,663 discloses a compressing apparatus having die filling means adapted to fill a die with formable material, adjustable means for regulating the amount of formable material received in the die and force applying means for applying compressing force to the material within the die. Means are provided for measuring the force applied to the formable material within the die by the force applying means and producing a control signal which varies in proportion to said measured force which in turn indicates the degree to which the die was filled during a given compression operation. Switching means is provided which is responsive to the control signal and adapted to effect adjustment of the adjustable die filling means to control the weight and, therefore, the amount of formable material in each of the dies.

DE 198 28 004 discloses a method of achieving a constant pressing force during main-compression of tablets in a tablet press in order to obtain a reduction of the variations of rupture strength of the tablets produced. The constant pressing force achieving process involves the use of adjustable pressing rollers controlled by a calculator. For each individual compressing process for each tablet, one of the pressing rollers is so positioned by positive and negative setting that a preset maximum pressing force is kept constant for a set time. Pressing force is read and regulated in real time. Furthermore, the integral of said pressing force over time may be utilized as control parameter for the dosing function of the press.

U.S. Pat. No. 4,680,158 discloses a rotary pelletizing machine comprising a rotatable matrix disc with a plurality of circumferentially distributed matrices, upper and lower punches located above and below the matrix disc respectively, at least two pre-pressing elements movable relative to one another and acting upon the upper and lower stamps so as to pre-press pellets of a material, at least two main pressing elements movable relative to one another and acting upon the upper and lower stamps so as to finally press the pellets of the material, an adjusting motor arranged to adjust a distance between the main pressing elements relative to one another, a computer device arranged to control the adjusting motor, and a device for measuring a pressing force of the pre-pressing elements and supplying data of the measurement to the computer device so that the computer device controls the adjusting motor and therefore the distance between the main pressing elements in dependence upon the measured pressing force of the pre-pressing elements. Thereby, the risk of rupture of the punches at the main pressing station is reduced.

EP 0 698 481 discloses a method for the quality assurance for tablet production by means of pressing by way of influential action on the pressing force, on the weight, on the hardness and the height of the tablets. The method involves dividing the control system into five loops interconnected for operation in parallel. The first loop (R1) adjusts the actual pressing force (PKIST) to a desired value (PKsoll) which is updated by the second loop (R2) in accordance with the measured weight deviation (delta G) and its slope (dG/dPK). The third and fourth loops (R3, R4) update the desired step height (PKsollst) for deviations in size (T) and hardness (H) of tablets. The fifth loop (R5) alternates with the first, correcting deviation (delta St) of the desired step height from the actual force. The control system is preferably based on fuzzy logic. However, due to the five control loops involved, this control system is complicated and consequently expensive to apply.

The object of the present invention is to provide a method for controlling a tablet press, whereby the quality of the produced tablets may be controlled more effectively during production according to preset values.

Additionally, it is an object of the present invention to provide a tablet press for carrying out such a method.

### BRIEF SUMMARY OF THE INVENTION

In view of this object, the method according to the invention comprises the steps:
consecutively supplying a quantity of material to be compressed into each die,
subjecting the quantity of material located in each die to a pre-compression and subsequently a main-compression,
measuring, during the pre-compression of the quantity of material located in each die, a value of a first parameter representative of the weight of the quantity of material fed into the die,
measuring, during the main-compression of the quantity of material located in each die, a value of a second parameter representative of the hardness of the tablet resulting from the compression,
regulating the quantity of material supplied to each die on the basis of a deviation between a previously measured value of the first parameter and a first set value, and
regulating the degree of compression that the quantity of material located in each die is subjected to during main-compression on the basis of a deviation between a previously measured value of the second parameter and a second set value.

By performing the regulation of the weight and the hardness of the tablets by means of a pre-compression and a main-compression procedure, respectively, compared to known systems, a more precise regulation of both weight and hardness may be obtained even after a very short running in period. In addition, the implementation of two regular control loops is simple compared to known approaches and consequently much more cost effective.

In an embodiment, said compression degree regulation is performed substantially independently of said powder quantity regulation.

In another embodiment, said compression degree regulation and said powder quantity regulation are interrelated.

In a further embodiment, said compression degree regulation is in addition performed on the basis of a measured value of the first parameter. Thereby, it is possible to correct measurements of a value of the second parameter on the basis of fluctuations of measured values of the first parameter, whereby the hardness regulation may be adapted according to given requirements.

In a preferred embodiment, said powder quantity regulation is based on a mean value of several single measured values of the first parameter, and said compression degree regulation is based on a mean value of several single measured values of the second parameter. Thereby, fluctuations of the quantity of material supplied to each die will not cause the control loops to overreact; instead, corrections to both the weight and the hardness of the tablets produced will be based on progressive deviations registered by the respective control loops.

In a further preferred embodiment, the quantity of powder fed consecutively into each die is maintained constant as long as said mean value of the first parameter falls within preset first correction tolerance limits, and the degree of compression during main-compression of consecutive tablets is maintained constant as long as said mean value of the second parameter falls within preset second correction tolerance limits. This will further prevent a possible tendency of the control loops to overreact, as corrections will only be performed when a measured value falls outside the preset limits.

In an embodiment, the first parameter corresponds substantially to a thickness of a tablet during pre-compression of said tablet under substantially constant compression force. This allows a very accurate regulation of the tablet weight, because there exists a linear relationship between the actual tablet weight which is to be regulated and a measured value of the parameter.

In another embodiment, the first parameter corresponds substantially to the maximum compression force exerted by a punch on a tablet during pre-compression of said tablet to a predetermined tablet thickness.

In an embodiment, the degree of compression during main-compression is regulated by adjusting the final thickness to which the tablet is compressed. This regulation is simple to realize and may be performed without influencing other parameters such as the rotational speed of the die table.

In an embodiment, the second parameter corresponds substantially to the maximum compression force exerted on a tablet during main-compression of said tablet to a predetermined tablet thickness. This parameter is quite straightforward to measure and is closely related to the resulting hardness of the tablet.

In another embodiment, the second parameter corresponds substantially to the time interval during which a tablet is compressed during main-compression of said tablet.

In an embodiment, said powder quantity regulation is re-calibrated periodically after ascertaining the weight of a number of tablets ejected from the die table, determining the mean tablet weight of said tablets, and comparing said mean tablet weight with a desired tablet weight. In this way, an even more accurate control of the actual resulting tablet weight may be obtained.

In an embodiment, said compression degree regulation is re-calibrated periodically after ascertaining the hardness of a number of tablets ejected from the die table, determining the mean tablet hardness of said tablets, and comparing said mean tablet hardness with a desired tablet hardness. In this way, an even more accurate control of the actual resulting tablet hardness may be obtained.

In an embodiment, compressed tablets having a measured first parameter value falling outside preset first rejection tolerance limits are separated automatically from the remaining tablets for rejection. This may ensure that individual tablets accidentally having a weight deviating particularly from a desired value may be rejected.

In an embodiment, compressed tablets having a measured second parameter value falling outside preset second rejection tolerance limits are separated automatically from the remaining tablets for rejection. This may ensure that individual tablets accidentally having a hardness deviating particularly from a desired value may be rejected.

In an embodiment, said method comprises the steps:
consecutively supplying a quantity of a first material to each die,
subjecting the quantity of the first material located in each die to a first layer pre-compression and subsequently a first layer main-compression, during which first layer main-compression the first material is compressed to a preset thickness of a first layer of the tablet,
subsequently to the first layer main-compression, supplying a quantity of a second material to each die,
subjecting the quantity of material located in each die to a second layer pre-compression and subsequently a double layer main-compression,
measuring, during the first layer pre-compression, a value of a first parameter representative of the weight of the quantity of the first material compressed,
regulating the quantity of the first material supplied to each die on the basis of a deviation between a previously measured value of the first parameter for the first material and a first set value for the first material,
measuring, during the second layer pre-compression, a value of a first parameter substantially representative of the weight of the quantity of the second material compressed,
regulating the quantity of the second material supplied to each die on the basis of a deviation between a previously measured value of the first parameter for the second material and a first set value for the second material,
measuring, during the double layer main-compression, a value of a second parameter representative of the hardness of the total tablet resulting from said main-compression,
regulating the degree of compression that the total quantity of the first material and the second material located in each die is subjected to during the double layer main-compression on the basis of a deviation between a previously measured value of the second parameter for the total double layer tablet and a second set value for the double layer tablet.

Further, in view of the above-mentioned object, in the tablet press according to the invention,
the housing comprises a feeding device for the supply of material to be compressed into the dies, a tablet discharge device for removal of compressed material in the form of tablets, and
at least one pre-compression station and at least one main-compression station, each said compression station being provided with first and second compression rollers adapted to interact with the second punch ends, respectively, in order to perform compression of material located in the dies by reciprocation of the punches,
the pre-compression station comprises a weight transducer for measuring a value of a first parameter representative of the weight of a quantity of material fed into a die,
the main-compression station comprises a hardness transducer for measuring a value of a second parameter representative of the hardness of a tablet resulting from a compression in the main-compression station,
a powder quantity regulator being provided for regulation of the quantity of material supplied to each die by the feeding device on the basis of a deviation between a value of the first parameter previously measured by the weight transducer and a first set value, and
a compression degree regulator being provided for regulation of the degree of compression that the quantity of material located in each die is subjected to in the main-compression station on the basis of a deviation between a value of the second parameter previously measured by the hardness transducer and a second set value.

Thereby, the above-mentioned advantages may be achieved.

In an embodiment, said compression degree regulator is adapted to operate substantially independently of said powder quantity regulator.

In another embodiment, said compression degree regulator and said powder quantity regulator are interrelated.

In a further embodiment, said compression degree regulator is in addition adapted to regulate on the basis of a measured value of the first parameter. Thereby, the above-mentioned advantages may be achieved.

In an embodiment, the powder quantity regulator is adapted to regulate the performance of the feeding device on the basis of a mean value of several single measured values of the first parameter, and the compression degree regulator is adapted to regulate the performance of the main-compression station on the basis of a mean value of several single measured values of the second parameter. Thereby, the above-mentioned advantages may be achieved.

In an embodiment, the powder quantity regulator is adapted to maintain the quantity of powder fed consecutively into each die constant as long said mean value of the first parameter falls within preset first correction tolerance limits, and the compression degree regulator is adapted to maintain the degree of compression exerted on consecutive tablets in the main-compression station constant as long as said mean value of the second parameter falls within preset second correction tolerance limits. Thereby, the above-mentioned advantages may be achieved.

In an embodiment, the first compression roller in the pre-compression station is suspended in a piston arranged displaceably in an air cylinder, said air cylinder being connected to a supply of compressed air and associated with a regulator adapted to maintain a constant air pressure in the air cylinder, and said weight transducer is adapted to measure the displacement of the piston in the air cylinder during compression of a tablet. Thereby, the first parameter measured by the weight transducer will correspond substantially to a thickness of a tablet during pre-compression of said tablet under substantially constant compression force. Thereby, the above-mentioned advantages may be achieved.

In an embodiment, the first compression roller in the pre-compression station is adapted to be substantially fixedly positioned during compression, and said weight transducer is adapted to measure the force exerted on said first compression roller by the second punch ends at compression.

In an advantageous embodiment, the powder quantity regulator is adapted to regulate the quantity of material to be compressed in each die by adjustment of the position of the second punches at the feeding device.

In an embodiment, at least one compression roller of the main-compression station is displaceable by means of a linear actuator, and the compression degree regulator is adapted to regulate the degree of compression performed in the main-compression station by adjustment of the position of said at least one compression roller of the main-compression station. Thereby, the degree of compression is regulated substantially by adjusting the final thickness to which the tablet is compressed and the above-mentioned advantages may be achieved.

In an embodiment, the first compression roller in the main-compression station is adapted to be substantially fixedly positioned during compression, and said hardness transducer is adapted to measure the force exerted on said first compression roller by the second punch ends at compression. Thereby, the second parameter may correspond substantially to the maximum compression force exerted on a tablet during main-compression and the above-mentioned advantages may be achieved.

In an embodiment, the tablet discharge device is connected to an automatic testing device adapted to ascertain the weight of a number of tablets ejected from the die table, determine the mean tablet weight of said tablets, and supply said mean tablet weight to the powder quantity regulator. Thereby, the above-mentioned advantages may be achieved.

In an embodiment, a compression roller of the pre-compression station is displaceable by means of a linear actuator, and the powder quantity regulator is adapted to adjust the position of said compression roller according to the mean tablet weight supplied by the automatic testing device. Thereby, it may be avoided to correct the first set value and the weight transducer may continuously work around a basic operating point.

In an embodiment, the tablet discharge device is connected to an automatic testing device adapted to ascertain the hardness of a number of tablets ejected from the die table, determine the mean tablet hardness of said tablets, and supply said mean tablet hardness to the compression degree regulator. Thereby, the above-mentioned advantages may be achieved.

In an embodiment, the tablet discharge device is connected to an automatic rejection device adapted to separate tablets having a measured first parameter value falling outside preset first rejection tolerance limits from the remaining tablets. Thereby, the above-mentioned advantages may be achieved.

In an embodiment, the tablet discharge device is connected to an automatic rejection device adapted to separate tablets having a measured second parameter value falling outside preset second rejection tolerance limits from the remaining tablets. Thereby, the above-mentioned advantages may be achieved.

In an embodiment, said tablet press comprises a first layer production section comprising a feeding device for a first material, a first layer pre-compression station and a first layer main-compression station, whereby said main-compression station is adapted for compression of a quantity of the first material to a preset thickness of a first layer of the tablet,
and a second layer production section comprising a feeding device for a second material, a tablet discharge device, a second layer pre-compression station and a second layer main-compression station,
the first layer pre-compression station comprising a weight transducer for measuring a value of a first parameter representative of the weight of a quantity of the first material compressed in the pre-compression station,
a first layer powder quantity regulator being provided for regulation of the quantity of material supplied to each die by the feeding device on the basis of a deviation between a previously measured value of the first parameter for the first material and a first set value for the first material, and
the second layer pre-compression station comprising a weight transducer for measuring a value of a first parameter representative of the weight of a quantity of the second material compressed in the pre-compression station,
a second layer powder quantity regulator being provided for regulation of the quantity of material supplied to each die by the feeding device on the basis of a deviation between a previously measured value of the first parameter for the second material and a first set value for the second material, and
the double layer main-compression station comprising a hardness transducer for measuring a value of a second parameter representative of the hardness of a total tablet resulting from said main-compression,
a double layer compression degree regulator being provided for regulation of the degree of compression that the total quantity of the first material and the second material located in each die is subjected to during the double layer main-compression on the basis of a deviation between a previously measured value of the second parameter for the total double layer tablet and a second set value for the double layer tablet.

### BRIEF DESCRIPTION OF THE SEVERAL VIEWS OF THE DRAWING

The invention will now be explained in more detail below by means of examples of embodiments with reference to the very schematic drawing, in which

FIG. 1 is a diagrammatic top view of a rotary die table of a tablet press, having associated pre-compression and main-compression stations, feeding device, tablet discharge device, tablet rejection device, tablet testing device and control system,

FIG. 2 is a side view of a part of the feeding device of FIG. 1,

FIG. 3 is a side view of the pre-compression station of FIG. 1, and

FIG. 4 is a side view of the main-compression station of FIG. 1.

### DETAILED DESCRIPTION OF THE INVENTION

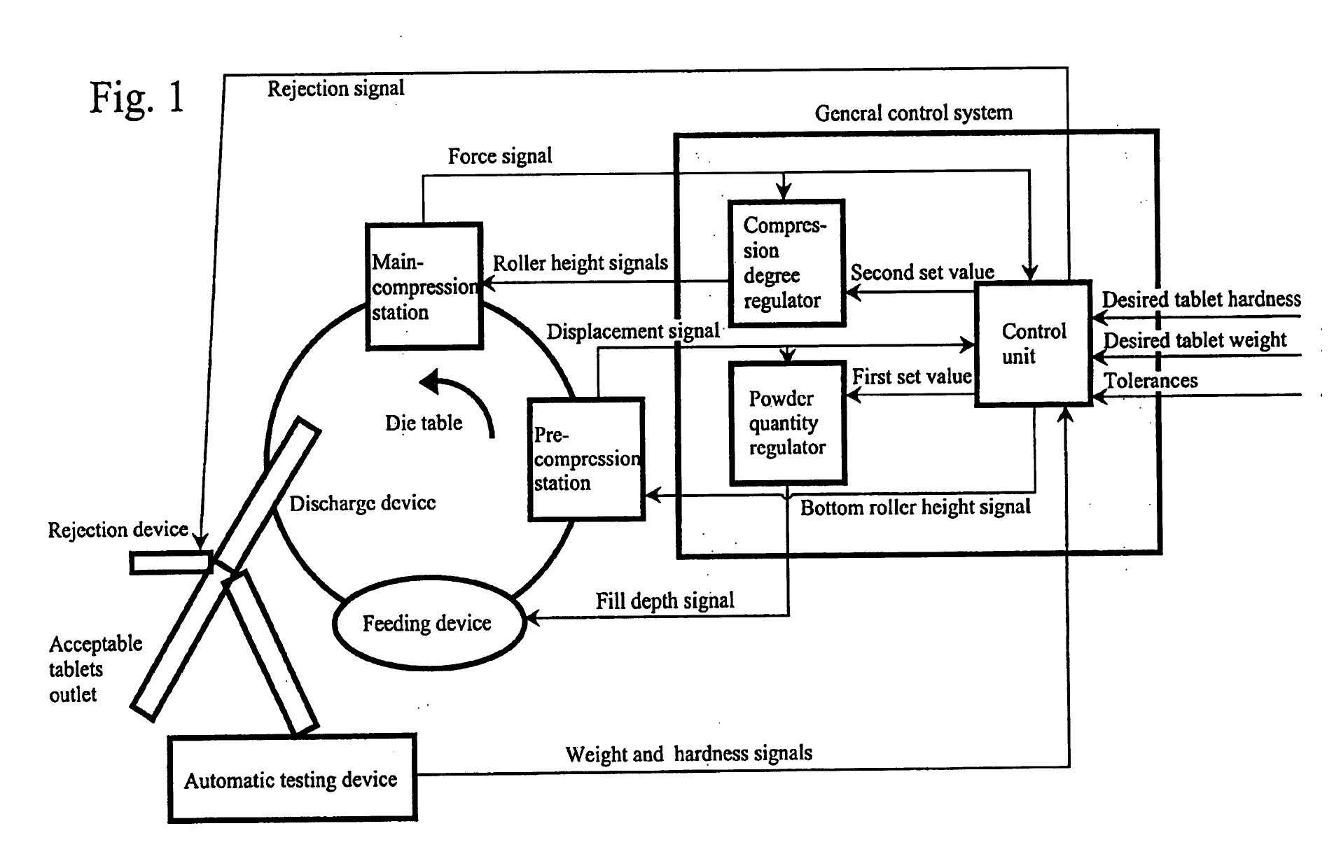

FIG. 1 shows in diagrammatic form an embodiment of a rotary tablet press with a control system according to the invention. The tablet press has a rotary die table 1 for compression of a feedstock in the form of powder or granular material into tablets, compacts or the like. The press is of a type suitable for use in the pharmaceutical industry, but the press according to the invention may as well be a so-called industrial press employed in the production of a variety of different products, such as vitamins, pet food, detergents, explosives, ceramics, batteries, balls, bearings, nuclear fuels, etc. The abbreviations indicated in FIG. 1 will be referred to in brackets in the following.

The tablet press is provided with a feeding device in the form of a well-known double rotary feeder with two not shown rotary paddles located in a feeder housing and driven by means of separate drive motors providing for independent speed setting of the paddles. The feeder housing is open against the die table so that the paddles may ensure proper filling of the dies with feedstock. Other feeding Systems may also be employed, such as a so-called gravity feeder or a vibration feeder.

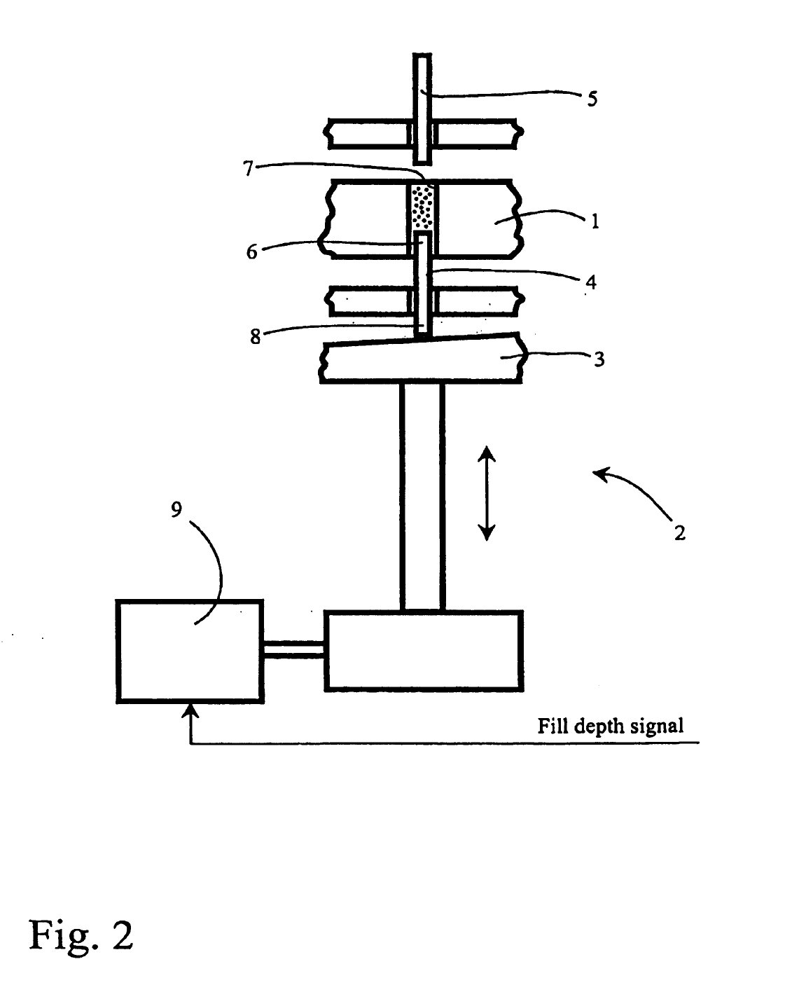

FIG. 2 shows a fill depth adjusting device 2 which in this description will be considered as a part of the feeding device. The rotary feeder itself is not shown in FIG. 2. The fill depth adjusting device 2 comprises a vertically displaceable cam 3 determining the vertical position of lower punches 4 at the feeding device, thereby determining the fill depth of the die. The fill depth determines in a manner known per se the quantity of material left in the dies for compression. The lower punches 4 have first ends 6 received in corresponding dies 7 of the die table 1 and second ends 8 sliding on the vertically displaceable cam 3. Upper punches 5 are maintained outside the dies 7 at this stage in order to permit filling of the dies. The vertical position of the cam 3 is adjusted by means of a linear actuator 9 in accordance with a fill depth signal received from a powder quantity regulator shown in FIG. 1.

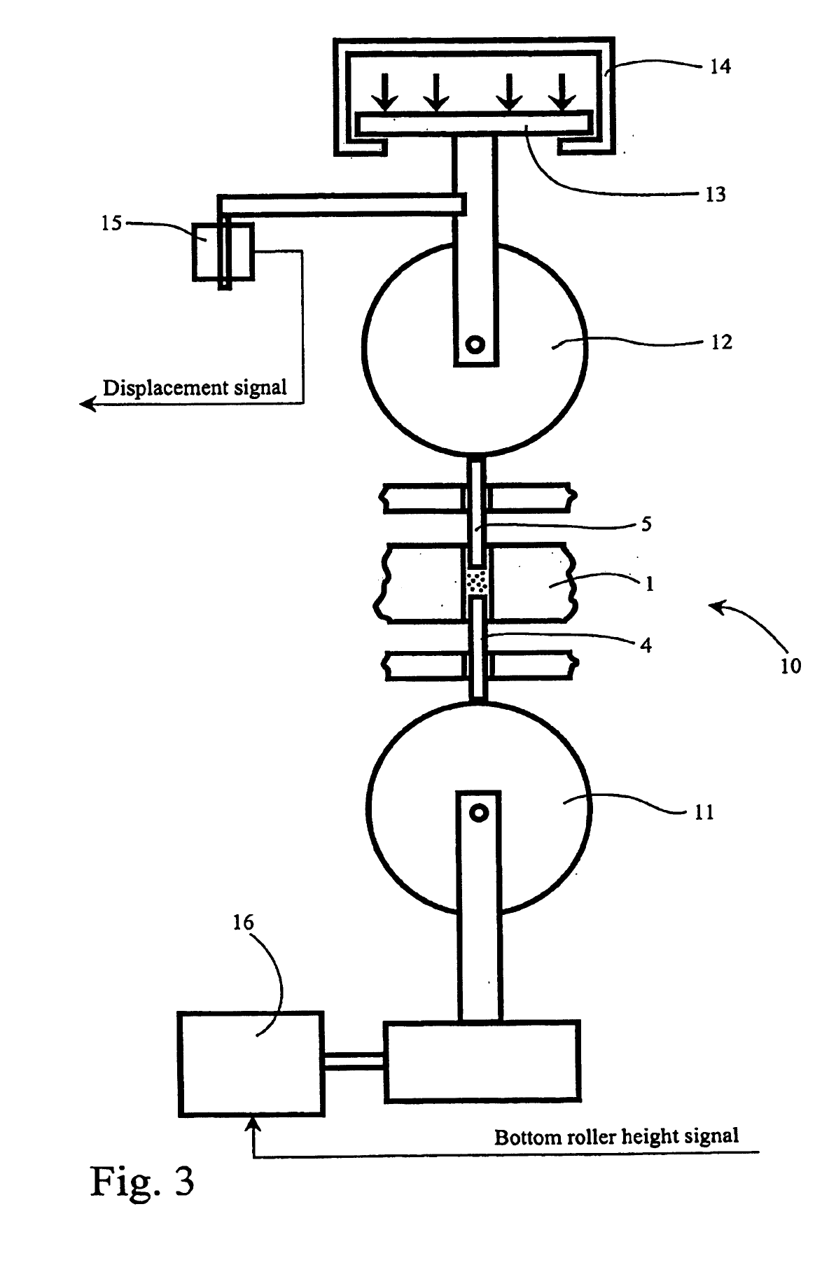

FIG. 3 shows a pre-compression station 10 comprising a lower compression roller 11 and an upper compression roller 12. The upper compression roller 12 is suspended in a piston 13 vertically displaceable in an air cylinder 14. The air pressure in the air cylinder 14 is maintained constant by means of a not shown regulation system. The vertical position of the piston 13 is measured by means of a displacement transducer 15, such as a LVDT (Linear Variable Differential Transformer). When an upper punch 5 passes under the centre of the upper compression roller 12, the displacement transducer 15 measures a displacement substantially corresponding to the thickness of the tablet after the pre-compression. Because the compression is being performed with a constant force being applied to the upper punch 5 by means of the piston 13, the displacement measured by the displacement transducer 15 corresponds to the weight of the tablet compressed. Due to this relationship, the displacement transducer 15 is also referred to as a weight transducer in this description. At each pre-compression of a tablet, the displacement measured by the displacement transducer 15 is transferred in the form of a displacement signal to the powder quantity regulator and the control unit, see FIG. 1,

In the control unit, the displacement signal supplied for each tablet produced is compared with pre-determined rejection tolerance limits defining the maximum acceptable deviation from a desired tablet weight. If the displacement signal for a tablet falls outside the rejection tolerance limits, a rejection signal is sent from the control unit to a rejection device associated with a tablet discharge device, and the tablet is separated from the remaining tablets, when it reaches the rejection device, see FIG. 1.

In the powder quantity regulator, a rigid or floating mean value of the displacement signal for several consecutive tablets is compared with a first set value which corresponds to a calibrated desired tablet weight and is received from the control unit. If the deviation falls outside preset first correction tolerance limits, the fill depth signal supplied to the feeding device is corrected correspondingly. Said correction tolerance limits may be calculated automatically by a general control system on the basis of user defined acceptable deviations, for instance in the form of percentage values, from the desired tablet weight.

From the tablet discharge device the tablets are fed to an automatic testing device, for example a Kraemer Electronic Tablet Tester, in which the weight and hardness of a number of sample tablets are determined periodically, and whereby corresponding weight and hardness signals are transferred to the control unit, see FIG. 1. In the control unit, the weight signal received from the automatic testing device is compared with the desired tablet weight, and on the basis of the deviation between these values, a bottom roller height signal is generated and transferred to the pre-compression station. In the pre-compression station, the bottom roller height signal is fed into a linear actuator 16, which adjusts the height of the bottom compression roller 11 correspondingly, see FIG. 3. In an alternative embodiment, the vertical position of the air cylinder 14 could be adjusted by means of a linear actuator. Thereby, the powder quantity regulation loop is re-calibrated on the basis of the actual tablet weights of the sampled tablets measured by the automatic testing device. It should be noted that said re-calibration could also be performed by adjustment of the first set value supplied to the powder quantity regulator by the control unit or by adjustment of the otherwise constant air pressure in the air cylinder 14. Furthermore, instead of using an automatic testing device, a number of sample tablets may be tested manually, and a measured weight and possibly hardness may then be entered in the general control system.

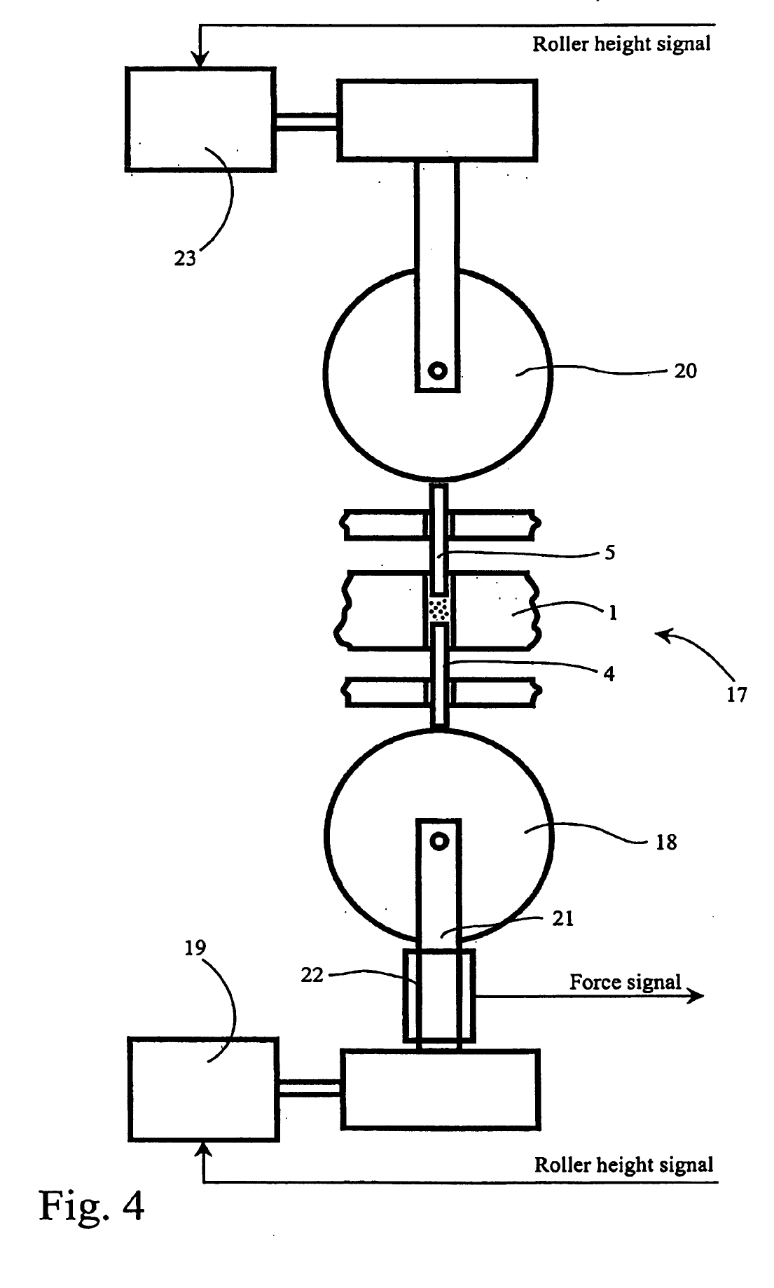

Referring now to FIG. 4, a main-compression station 17 comprises a bottom compression roller 18, which is vertically adjustable by means of a linear actuator 19 and is suspended in a shaft 21 provided with a strain gauge 22 by means of which a force signal is supplied to a compression degree regulator and to the control unit. Furthermore, the main-compression station 17 comprises a top compression, roller 20 vertically adjustable by means of a linear actuator 23. The strain gauge 22 could, naturally, also be arranged at the top compression roller 20. Other suitable force measurement devices than a strain gauge could be employed. The force signal is supplied by the strain gauge 22 in a manner know pert se and corresponds to the force supplied by the bottom compression roller 18 to the bottom punch 4 during the main-compression of the tablet. The compression degree regulator compares a rigid or floating mean value of the force signal received from the strain gauge 22 for several consecutive tablets with a second set value received from the control unit, and roller height signals based on the deviation between these values are generated and transmitted to the main-compression station, where they are supplied to the linear actuator 19 and to the linear actuator 23, whereby the vertical height of the bottom compression roller 18 and/or the vertical height of the top compression roller 20 is/are adjusted accordingly. The force signal supplied to the control unit is, for each individual tablet, compared with rejection hardness tolerance limits defining the acceptable deviation from a desired tablet hardness. If the hardness of a tablet falls outside the rejection tolerance limits, a rejection signal is sent to the rejection device, and the tablet is separated from the remaining tablets for rejection. The transmission of said rejection signal could, of course, be omitted, if the actual hardness of individual tablets is less critical. The hardness signals periodically supplied from the automatic testing device to the control unit are compared with the desired tablet hardness, and on the basis of the deviation between these values, the second set value supplied from the control unit to the compression degree regulator is corrected correspondingly, whereby the compression degree regulation loop is re-calibrated.

In the embodiment shown in FIG. 1, the displacement signal corresponds to the previously mentioned first, parameter corresponding substantially to a thickness of a tablet during pre-compression of said tablet under substantially constant compression force, and the force signal corresponds to the previously mentioned second parameter corresponding substantially to the maximum compression force exerted on a tablet during main-compression of said tablet to a predetermined tablet thickness. The displacement signal and the force signal may be measured when they reach their maximum values, respectively, whereby the point in time at which a measurement is to be performed may be determined by means of proximity switches detecting the position of the die table in a manner known per se. However, the points in time for the measurements may be determined in any suitable way, for instance by devices coupled to the drive system of the die table. Furthermore, it is not a requirement that the first and second parameters are measured exactly when they reach their maximum values if only the values measured correspond substantially to the weight and hardness, respectively, of the compressed tablets.

Alternatively to the shown embodiment, and as discussed above, the first parameter corresponding substantially to the thickness of a tablet could also be measured in the form of a force signal, in which case the set-up for the pre-compression station would correspond substantially to that of the main-compression station shown in FIG. 4. Furthermore, the second parameter corresponding to the hardness of a compressed tablet could be measured in the form of a time interval during which a tablet is compressed. The compression degree regulator may, instead of regulating the thickness to which a tablet is to be compressed, regulate the actual compression force in real time to obtain a constant compression force. Any combination of the mentioned set-ups for measurement and regulation may be employed according to the situation given.

Although the powder quantity regulator, the compression degree regulator and the control unit are shown as separate units in the general control system, these unite may be separate units communicating with each other or may be one integrated unit, such as a computer. The mentioned regulators may be hardware implemented, PLC (programmable logic controller) regulators, or software implemented.

Where the compression degree regulation in the present context is described as being performed substantially independently of the powder quantity regulation, this should be perceived as meaning that the two regulation loops in that case have no interconnection by means of feed forward or feed backward of control signals. It is not intended to mean that there will be no interaction between those two regulation loops. Indeed, if for instance the actual tablet weight is near an upper correction tolerance limit, a larger force will be measured at main-compression than if said tablet weight were near a lower correction tolerance limit, and consequently the hardness regulation will be influenced. However, these fluctuations may, depending on the application, be ignored.

Where the compression degree regulation and the powder quantity regulation in the present context are described as being interrelated, this should be perceived as meaning that at least one control signal is either fed forward or backward between the two regulation loops. For instance, if the actual tablet weight falls outside a first narrow tolerance interval, but within a second broader tolerance interval, the powder quantity regulator may not regulate the fill depth, but a correction signal may be transmitted to the compression degree regulator, thereby correcting the force value measured by the hardness transducer.

The general control system comprises a user interface, by means of which the user may enter desired values for tablet weight, tablet hardness, tablet thickness and tolerances of these parameters. Because the hardness and thickness of a tablet are interrelated variables, it is possible that the user instead of a desired tablet hardness, as in the examples discussed above, may enter a desired tablet thickness. The system may then calculate the corresponding desired hardness, on the basis of which the compression degree will be regulated. The system may even take into account both a desired hardness and a desired thickness and then calculate a compromise on the basis of which to regulate. The automatic testing device may apart from the tablet weight and the tablet hardness also measure the tablet thickness. All of these values may be read out by the system and utilized to survey the operation of the press which may be stopped in case that the measured variables exceed preset values.

Obviously, the invention is equally applicable to so-called single sided, double aided or multi sided tablet presses. For instance, in a double sided press for the production of tablets having two layers, a first layer production section and a second layer production section, arranged along opposite sides of the die table, each has both a pre-compression station and a main-compression station. In this case, the hardness of the first layer is not regulated in the main-compression station of the first layer production section, although the hardness may be surveyed. Instead, the first layer is compressed to a fixed thickness at main-compression in order to better be able to regulate the quantity of the second material supplied to each die. Similarly, in a press for production of tablets having more than two layers, hardness is only regulated at main-compression in the production section of the last layer.

In a double sided press for the production of double layer tablets, substantially only the second layer is compressed at pre-compression subsequently to feeding the second layer material; therefore this is referred to as second layer pre-compression in the present description. At the subsequent main-compression a greater force is employed, so that indeed both layers are compressed, which is referred to as double layer main-compression.

In a double sided press for the production of single layer tablets, two similar production sections are provided, arranged along opposite sides of the die table, and each has both a pre-compression station, a main-compression station, a feeding device, and a tablet discharge device. Each production section is provided with both a powder quantity regulator and a compression degree regulator.

In the following, typical values of control parameters will be given only by means of examples. These values should however in no way be construed as limiting for the scope of the invention.

For the set-up of a single aided tablet press as shown in FIG. 1, a constant force of 10 kN is applied to the tablets in the pre-compression station, and the first set value is set to a displacement of 0.2 mm. Upper and lower first correction tolerance limits are set to 0.22 mm and 0.18 mm, respectively. A floating mean value of the measured displacement for 30 consecutive tablets is created and compared with said limits. Upper and lower first rejection tolerance limits are set to 0.3 mm and 0.1 mm, respectively. The weight re-calibration is performed in the following way. When the deviation between the desired tablet weight and the measured average weight of a sample of 20 tablets is X %, the bottom roller height is changed with a value of X % of the total of the so-called pre-compression height plus the actually measured average displacement of the piston 13 from its rest position. The pre-compression height is defined as a theoretical distance between the first punch ends, occurring if these were right between the centres of the compression rollers without material in the relevant die.

For the main-compression, the second set value is set to a force of 35 kN as a starting point, which will be re-calibrated periodically by means of the automatic testing device. Upper and lower second correction tolerance limits are set to 36.75 kN and 33.25 kN, respectively. A floating mean value of the measured compression force for 30 consecutive tablets is created and compared with said limits. Second rejection tolerance limits may be set if necessary. The hardness re-calibration is performed in the following way. When the deviation between the desired tablet hardness and measured average hardness is +Y %, then the second set value will be changed with (−Y %)*CFFH, whereby CFFH is the “correction factor force versus hardness”. The value of CFFH can be determined as a function of the powder characteristics (granule size and distribution) tablet characteristics (size, shape), and compression characteristics (compression force, compression speed, compression ratio) and is automatically determined by the tablet press control system. If, for instance, the actual second set value is 35 kN, and a sample of 10 tablets is measured and has a hardness value of 4% above the desired tablet hardness, and the CFFH value is 0.8, then the second set value will be changed with (−4% *0.8). The CFFH may be a fixed value or depend on the hardness deviations.

In the above example, the pre-compression may alternatively be regulated by means of force measurements as follows. The first set value is set to a force of 25 kN. Upper and lower first correction tolerance limits are set to 25.75 kN and 24.25 kN, respectively. A floating mean value of the measured compression force for 30 consecutive tablets is created and compared with said limits. Upper and lower first rejection tolerance limits are set to 27.5 kN and 22.5 kN, respectively.

1. A method for controlling a tablet press, whereby powder or granular material is compressed in dies arranged circumferentially in a rotary die table by means of reciprocating punches, said method comprising the steps:
consecutively supplying a quantity of material to be compressed into each die,
subjecting the quantity of material located in each die to a pre-compression and subsequently a main-compression,
measuring, during the pre-compression of the quantity of material located in each die, a value of a first parameter representative of the weight of the quantity of material fed into the die,
measuring, during the main-compression of the quantity of material located in each die, a value of a second parameter representative of the hardness of the tablet resulting from the compression,
regulating the quantity of material supplied to each die on the basis of a deviation between a previously measured value of the first parameter and a first set value, and
regulating the degree of compression that the quantity of material located in each die is subjected to during main-compression on the basis of a deviation between a previously measured value of the second parameter and a second set value.

2. A method according to claim 1, wherein said compression degree regulation is performed substantially independently of said powder quantity regulation.

3. A method according to claim 1, wherein said compression degree regulation and said powder quantity regulation are interrelated.

4. A method according to claim 1, wherein said compression degree regulation in addition is performed on the basis of a measured value of the first parameter.

5. A method according to claim 1, wherein said powder quantity regulation is based on a mean value of several single measured values of the first parameter, and said compression degree regulation is based on a mean value of several single measured values of the second parameter.

6. A method according to claim 5, wherein the quantity of powder fed consecutively into each die is maintained constant as long as said mean value of the first parameter falls within preset first correction tolerance limits, and wherein the degree of compression during main-compression of consecutive tablets is maintained constant as long as said mean value of the second parameter falls within preset second correction tolerance limits.

7. A method according to claim 1, wherein the first parameter corresponds substantially to a thickness of a tablet during pre-compression of said tablet under substantially constant compression force.

8. A method according to claim 1, wherein the first parameter corresponds substantially to the maximum compression force exerted by a punch on a tablet during pre-compression of said tablet to a predetermined tablet thickness.

9. A method according to claim 1, wherein the degree of compression during main-compression is regulated by adjusting the final thickness to which the tablet is compressed.

10. A method according to claim 1, wherein the second parameter corresponds substantially to the maximum compression force exerted on a tablet during main-compression of said tablet to a predetermined tablet thickness.

11. A method according to claim 1, wherein the second parameter corresponds substantially to the time interval during which a tablet is compressed during main-compression of said tablet.

12. A method according to claim 1, wherein said powder quantity regulation is re-calibrated periodically after ascertaining the weight of a number of tablets ejected from the die table, determining the mean tablet weight of said tablets, and comparing said mean tablet weight with a desired tablet weight.

13. A method according to claim 1, wherein said compression degree regulation is re-calibrated periodically after ascertaining the hardness of a number of tablets ejected from the die table, determining the mean tablet hardness of said tablets, and comparing said mean tablet hardness with a desired tablet hardness.

14. A method according to claim 1, wherein compressed tablets having a measured first parameter value falling outside preset first rejection tolerance limits are separated automatically from the remaining tablets for rejection.

15. A method according to claim 1, wherein compressed tablets having a measured second parameter value falling outside preset second rejection tolerance limits are separated automatically from the remaining tablets for rejection.

16. A method according to claim 1, said method comprising the steps:
consecutively supplying a quantity of a first material to each die,
subjecting the quantity of the first material located in each die to a first layer pre-compression and subsequently a first layer main-compression, during which first layer main-compression the first material is compressed to a preset thickness of a first layer of the tablet,
subsequently to the first layer main-compression, supplying a quantity of a second material to each die,
subjecting the quantity of material located in each die to a second layer pre-compression and subsequently a double layer main-compression,
measuring, during the first layer pre-compression, a value of a first parameter representative of the weight of the quantity of the first material compressed,
regulating the quantity of the first material supplied to each die on the basis of a deviation between a previously measured value of the first parameter for the first material and a first set value for the first material,
measuring, during the second layer pre-compression, a value of a first parameter substantially representative of the weight of the quantity of the second material compressed,
regulating the quantity of the second material supplied to each die on the basis of a deviation between a previously measured value of the first parameter for the second material and a first set value for the second material,
measuring, during the double layer main-compression, a value of a second parameter representative of the hardness of the total tablet resulting from said main-compression,
regulating the degree of compression that the total quantity of the first material and the second material located in each die is subjected to during the double layer main-compression on the basis of a deviation between a previously measured value of the second parameter for the total double layer tablet and a second set value for the double layer tablet.

17. A rotary tablet press comprising a housing and a rotary die table having a number of dies arranged circumferentially, each die being associated with first and second punches, each punch having first and second ends, said first punch ends being receivable in the die and arranged for compression of a powder or granular material in the die,
the housing comprising a feeding device for the supply of material to be compressed into the dies, a tablet discharge device for removal of compressed material in the form of tablets, and
at least one pre-compression station and at least one main-compression station, each said compression station being provided with first and second compression rollers adapted to interact with the second punch ends, respectively, in order to perform compression of material located in the dies by reciprocation of the punches,
the pre-compression station comprising a weight transducer for measuring a value of a first parameter representative of the weight of a quantity of material fed into a die,
the main-compression station comprising a hardness transducer for measuring a value of a second parameter representative of the hardness of a tablet resulting from a compression in the main-compression station,
a powder quantity regulator being provided for regulation of the quantity of material supplied to each die by the feeding device on the basis of a deviation between a value of the first parameter previously measured by the weight transducer and a first set value, and
a compression degree regulator being provided for regulation of the degree of compression that the quantity of material located in each die is subjected to in the main-compression station on the basis of a deviation between a value of the second parameter previously measured by the hardness transducer and a second set value.

18. A rotary tablet press according to claim 17, wherein said compression degree regulator is adapted to operate substantially independently of said powder quantity regulator.

19. A rotary tablet press according to claim 17, wherein said compression degree regulator and said powder quantity regulator are interrelated.

20. A rotary tablet press according to claim 17, wherein said compression degree regulator in addition is adapted to regulate on the basis of a measured value of the first parameter.

21. A rotary tablet press according to claim 17, wherein the powder quantity regulator is adapted to regulate the performance of the feeding device on the basis of a mean value of several single measured values of the first parameter, and the compression degree regulator is adapted to regulate the performance of the main-compression station on the basis of a mean value of several single measured values of the second parameter.

22. A rotary tablet press according to claim 21, wherein the powder quantity regulator is adapted to maintain the quantity of powder fed consecutively into each die constant as long as said mean value of the first parameter falls within preset first correction tolerance limits, and wherein the compression degree regulator is adapted to maintain the degree of compression exerted on consecutive tablets in the main-compression station constant as long as said mean value of the second parameter falls within preset second correction tolerance limits.

23. A rotary tablet press according to claim 17, wherein the first compression roller in the pre-compression station is suspended in a piston arranged displaceably in an air cylinder, said air cylinder being connected to a supply of compressed air and associated with a regulator adapted to maintain a constant air pressure in the air cylinder, and wherein said weight transducer is adapted to measure the displacement of the piston in the air cylinder during compression of a tablet.

24. A rotary tablet press according to claim 17, wherein the first compression roller in the pre-compression station is adapted to be substantially fixedly positioned during compression, and wherein said weight transducer is adapted to measure the force exerted on said first compression roller by the second punch ends at compression.

25. A rotary tablet press according to claim 17, wherein the powder quantity regulator is adapted to regulate the quantity of material to be compressed in each die by adjustment, of the position of the second punches at the feeding device.

26. A rotary tablet press according to claim 17, wherein at least one compression roller of the main-compression station is displaceable by means of a linear actuator, and wherein the compression degree regulator is adapted to regulate the degree of compression performed in the main-compression station by adjustment of the position of said at least one compression roller of the main-compression station.

27. A rotary tablet press according to claim 17, wherein the first compression roller in the main-compression station is adapted to be substantially fixedly positioned during compression, and wherein said hardness transducer is adapted to measure the force exerted on said first compression roller by the second punch ends at compression.

28. A rotary tablet press according to claim 17, wherein the tablet discharge device is connected to an automatic testing device adapted to ascertain the weight of a number of tablets ejected from the die table, determine the mean tablet weight of said tablets, and supply said mean tablet weight to the powder quantity regulator.

29. A rotary tablet press according to claim 28, wherein a compression roller of the pre-compression station is displaceable by means of a linear actuator, and wherein a general control system is adapted to adjust the position of said compression roller according to the mean tablet weight supplied by the automatic testing device.

30. A rotary tablet press according to claim 17, wherein the tablet discharge device is connected to an automatic testing device adapted to ascertain the hardness of a number of tablets ejected from the die table, determine the mean tablet hardness of said tablets, and supply said mean tablet hardness to the compression degree regulator.

31. A rotary tablet press according to claim 17, wherein the tablet discharge device is connected to an automatic rejection device adapted to separate tablets having a measured first parameter value falling outside preset first rejection tolerance limits from the remaining tablets.

32. A rotary tablet press according to claim 17, wherein the tablet discharge device is connected to an automatic rejection device adapted to separate tablets having a measured second parameter value falling outside preset second rejection tolerance limits from the remaining tablets.

33. A rotary tablet press according to claim 17, said tablet press comprising
a first layer production section comprising a feeding device for a first material, a first layer pre-compression station and a first layer main-compression station, whereby said main-compression station is adapted for compression of a quantity of the first material to a preset thickness of a first layer of the tablet,
and a second layer production section comprising a feeding device for a second material, a tablet discharge device, a second layer pre-compression station and a second layer main-compression station,
the first layer pre-compression station comprising a weight transducer for measuring a value of a first parameter representative of the weight of a quantity of the first material compressed in the pre-compression station,
a first layer powder quantity regulator being provided for regulation of the quantity of material supplied to each die by the feeding device on the basis of a deviation between a previously measured value of the first parameter for the first material and a first set value for the first material, and
the second layer pre-compression station comprising a weight transducer for measuring a value of a first parameter representative of the weight of a quantity of the second material compressed in the pre-compression station,
a second layer powder quantity regulator being provided for regulation of the quantity of material supplied to each die by the feeding device on the basis of a deviation between a previously measured value of the first parameter for the second material and a first set value for the second material, and
the double layer main-compression station comprising a hardness transducer for measuring a value of a second parameter representative of the hardness of a total tablet resulting from said main-compression,
a double layer compression degree regulator being provided for regulation of the degree of compression that the total quantity of the first material and the second material located in each die is subjected to during the double layer main-compression on the basis of a deviation between a previously measured value of the second parameter for the total double layer tablet and a second set value for the double layer tablet.
